(19) United States
(12) Patent Application Publication
(10) Pub. No.: US 2013/0088530 A1
(43) Pub. Date: Apr. 11, 2013

(54) METHOD OF DRIVING LIQUID CRYSTAL DISPLAY ELEMENT AND LIQUID CRYSTAL DISPLAY ELEMENT DRIVING DEVICE

(71) Applicants: Mitsuhiro Shigeta, Osaka (JP); Nobuo Okano, Osaka (JP); Toshihisa Uchida, Osaka (JP); Yukio Yoshida, Osaka (JP); Kazuya Nakahata, Osaka (JP)

(72) Inventors: Mitsuhiro Shigeta, Osaka (JP); Nobuo Okano, Osaka (JP); Toshihisa Uchida, Osaka (JP); Yukio Yoshida, Osaka (JP); Kazuya Nakahata, Osaka (JP)

(73) Assignee: SHARP KABUSHIKI KAISHA, Osaka (JP)

(21) Appl. No.: 13/702,712

(22) PCT Filed: Jun. 3, 2011
(86) PCT No.: PCT/JP2011/062765

§ 371 Date: Dec. 7, 2012

(30) Foreign Application Priority Data
Jun. 24, 2010 (JP) 2010-143899

(51) Int. Cl. G09G 3/36

(52) U.S. Cl. CPC G09G 3/36
USPC 345/690

(57) ABSTRACT

In a method of driving a liquid crystal panel, an overshoot signal is applied to the liquid crystal panel to display images on the liquid crystal panel. An overshoot level C is selected from a plurality of overshoot levels Dn. In this selecting, difference values between momentary values of a response waveform gn and momentary values of an ideal waveform f are obtained and added for a predetermined period and a minimum first error value E1 is obtained. One of the overshoot levels Dn corresponding to the response waveform gn having the minimum first error value E1 is selected as the overshoot level C. One of the overshoot levels Dn is selected by using an average value from the values obtained for the predetermined period similarly to humans' recognition of the liquid crystal display element. Accordingly, tailing or an image failure is less likely to occur.

### TECHNICAL FIELD

The present invention relates to a method of driving a liquid crystal display element and a liquid crystal display element driving device, and especially relates to a method of driving a liquid crystal display element in which effectively selecting an overshoot level when applying an overshoot signal to drive a liquid crystal display element and display an image.

### BACKGROUND ART

High-performance liquid crystal display devices such as large screen televisions have been used widely and such liquid crystal display devices have advantages in a light weight, small power consumption, and small heat radiation compared to cathode-ray tube monitors. However, in the liquid crystal display device, alignment of the liquid crystal molecules are required to be changed every time different display images are displayed and this delays a response speed. Therefore, the response speed is required to be increased.

Patent document 1 discloses overdrive that is known as a technology for improving the response speed of the liquid crystal display element. In this technology, if the liquid crystal display element is controlled to rise a gradation level of display from a gradation level A to a gradation level B that is a rising response, an overshoot signal is applied to the liquid crystal display element as an image signal. In inputting the overshoot signal for the rising response, an image signal corresponding to a gradation level C that is higher than the gradation level B is temporally input to the liquid crystal display element and thereafter, an image signal corresponding to target gradation level B is input. If the liquid crystal display element is controlled to lower the gradation level from the gradation level A to the gradation level B that is a decaying response, an overshoot signal is applied to the liquid crystal display element as an image signal. In inputting the overshoot signal for the decaying response, an image signal corresponding to the gradation level C that is lower than the gradation level B is temporally input to the liquid crystal display element and thereafter, an image signal corresponding to the target gradation level B is input. In the overdrive, the alignment of the liquid crystal molecules is changed more promptly by the input of the image signal corresponding to the gradation level C compared to a case without such input of image signal corresponding to the gradation level C. This improves the response speed.
[Patent Document 1] Japanese Unexamined Patent Publication No. 2005-172882

### Problem to be Solved by the Invention

In the technology disclosed in Patent Document 1, in selecting a level of the gradation C in the overdrive, the image signal corresponding to the gradation level C is first applied to the liquid crystal display element and then reached gradation level is obtained after elapse of a predetermined time and a level of the gradation C is selected based on the obtained reached gradation level. However, even using the technology described in Patent Document 1, tailing or image failure of moving images is likely to be caused. In recognizing brightness, human beings obtains average brightness based on the brightness obtained for a predetermined time period with their eyes and recognize the average brightness as input brightness. If a human being sees a moving image displayed on the liquid crystal display element, he or she obtains momentary values of a response waveform of the liquid crystal display element for a predetermined time period and obtains an average value from the momentary values, and calculates an average gradation level based on the average value. The human being recognizes the calculated average gradation level as a gradation level of the liquid crystal display element. Therefore, even if the reached gradation level obtained after the predetermined time has elapsed from the application of the image signal corresponding to the gradation level C reaches the target gradation level B, and if the calculated average gradation level obtained with humans' recognition is different from the target gradation level B, a human being may recognize an afterimage (tailing) or may not recognize a correct image (may recognize an image failure).

### DISCLOSURE OF THE PRESENT INVENTION

The present technology was accomplished in view of the above circumstances. It is an object of the present technology to provide a technology in which tailing or an image failure is less likely to be caused in a moving image.

### Means for Solving the Problem

To solve the above problem, a method of driving a liquid crystal display element includes selecting an overshoot level C from a plurality of shoot levels Dn in a case that a gradation level changes from a gradation level A before changing a gradation level, a gradation level C corresponding to an overshoot signal, and a gradation level B that is a target gradation, in this order, and applying the overshoot level C selected by the selecting step to the liquid crystal display element. The selecting step includes obtaining a plurality of response waveforms gn each corresponding to each of the plurality of overshoot levels Dn, setting an ideal waveform f that is an ideal response waveform with which the gradation level is shifted from the gradation level A to the gradation level B in an ideal manner, obtaining difference values between corresponding momentary values of one of the response waveforms gn and momentary values of the ideal response waveform f for a plurality of times for a predetermined time period, adding the difference values obtained for the predetermined time period and obtaining a minimum first error value E1, and selecting one of the overshoot levels Dn that corresponds to the response waveform gn having the minimum first error value E1 as the overshoot level C.

According to the present technology, difference values between the corresponding momentary values of one of the response waveforms gn and the momentary values of the ideal response waveform f that are obtained for a predetermined time period are added to calculate the first error value E1. An overshoot level C having a minimum first error value E1 is selected. “Minimum” is referred to minimum difference. The first error value E1 includes an average value that is obtained from difference values between the corresponding momentary values of the response waveform gn and the momentary values of the ideal waveform f. Therefore, one of the overshoot levels Dn is selected with using an average value that is obtained from the values that are obtained for a predetermined time period similarly to the recognition of the liquid crystal display element by humans' eyes. Accordingly, a tailing or an image failure is less likely to occur.

In the adding step, it is preferable to exponentiate the difference value between the response waveform gn and the ideal waveform f with an exponent of 1 or more, and carry out the exponentiation a plurality of times for the predetermined time period and add values obtained by the exponentiation for the predetermined time period and obtaining the minimum first error value E1. In exponentiating the difference value between the response waveform gn and the ideal waveform f with the exponent of 1 or more, as the difference value is greater, the first error value E1 increases, and as the difference value is smaller, the first error value E1 decreases. With this method, one of the overshoot levels Dn that has a minimum first error value E1 is precisely selected.

The one of the overshoot levels Dn is preferably selected as the overshoot level C with using Newton method. One of the overshoot levels Dn that has a minimum first error value E1 is selected precisely by executing the selecting process repeatedly with using Newton method.

The exponent is preferably 1. If the exponent is 1, one of the overshoot levels Dn that has a minimum second error value E2 is selected promptly by using Newton method compared to a case in which other exponent is used.

Another aspect of the present technology is a method of driving a liquid crystal display element that includes selecting an overshoot level C from a plurality of shoot levels Dn in a case that a gradation level changes from a gradation level A before changing a gradation level, a gradation level C corresponding to an overshoot signal, and a gradation level B that is a target gradation, in this order, and applying the overshoot level C selected by the selecting step to the liquid crystal display element. The selecting step includes obtaining a plurality of response waveforms gn each corresponding to each of the plurality of overshoot levels Dn, setting an ideal waveform f that is an ideal response waveform with which the gradation level is shifted from the gradation level A to the gradation level B in an ideal manner, obtaining a function value with a first function Gn in which momentary values of one of the response values gn are obtained and added for a predetermined time period and by changing addition start time at which the adding of the momentary values of the response value is started, the function value changes as time passes, obtaining a function value with a second function F in which momentary values of the ideal waveform f are obtained and added for the predetermined time period and by changing addition start time at which the adding of the momentary values of the ideal waveform f is started, the function value changes as time passes, obtaining difference values between the corresponding function values of the first function Gn and the second function F for the predetermined time period, and adding the difference values obtained for the predetermined time period and obtaining a second minimum error value E2, and selecting one of the overshoot levels Dn that corresponds to the response waveform gn having the minimum second error value E2 as the overshoot level C.

With this technology, the function values are obtained with each of the first function Gn and the second function F in which momentary values of each of the response waveform gn and the ideal waveform f are added for a predetermined time period. The difference values between the corresponding functions values obtained with each of the first function Gn and the second function F are obtained and added to calculate the second error value E2. The overshoot level C having a minimum second error value E2 is selected. “Minimum” is referred to a minimum difference value. With the first function Gn and the second function F, an average value is obtained from a plurality of values of the response waveform gn and the ideal waveform f. The second error value E2 includes an average value that is obtained from difference values of the function values of the first function Gn and the second function F. Therefore, similarly to the recognition by humans' eyes, one of the overshoot levels Dn is selected by using the average value calculated from the values obtained for a predetermined period. Tailing or an image failure is less likely to occur.

In adding the difference values, it is preferable to exponentiate the difference value between the function values of the first function Gn and the second function F with an exponent of 1 or more, and carry out the exponentiation a plurality of times for the predetermined time period and add values obtained by the exponentiation for the predetermined time period and obtain the minimum second error value E2. In exponentiating the difference value between the function values of the first function Gn and the second function F with the exponent of 1 or more, as the difference value is greater, the second error value E2 increases, and as the difference value is smaller, the second error value E2 decreases. With this technology, one of the overshoot levels Dn that has a minimum second error value E2 is precisely selected.

The one of the overshoot levels Dn is preferably selected as the overshoot level C with using Newton method. One of the overshoot levels Dn that has a minimum second error value E2 is selected precisely by executing the selecting process repeatedly with using Newton method.

The exponent is preferably 1. If the exponent is 1, one of the overshoot levels Dn that has a minimum first error value E1 is selected promptly by using Newton method compared to a case in which other exponent is used.

Another aspect of the present technology includes a method of driving a liquid crystal display element that includes selecting an overshoot level C from a plurality of shoot levels Dn in a case that a gradation level changes from a gradation level A before changing a gradation level, a gradation level C corresponding to an overshoot signal, and a gradation level B that is a target gradation, in this order, and applying the overshoot level C selected by the selecting step to the liquid crystal display element. The selecting step includes obtaining a plurality of response waveforms gn each corresponding to each of the plurality of overshoot levels Dn, setting an ideal waveform f that is an ideal response waveform with which the gradation level is shifted from the gradation level A to the gradation level B in an ideal manner, obtaining a function value with a first function Gn in which momentary values of one of the response values gn are obtained and added for a predetermined time period and by changing addition start time at which the adding of the momentary values of the response value is started, the function value changes as time passes, and setting a conversion table K based on which a function value obtained by the first function Gn is converted to a gradation level X. The method further includes setting a parameter table P corresponding to one of the overshoot levels Dn for each of the gradation level A and the gradation level B. In the setting step, setting one of the overshoot levels Dn based on a difference value S between the gradation level X after elapse of a predetermined time period and a gradation level Y of the response waveform gn, and in the selecting step, selecting the overshoot level C based on the parameter table P.

In the present technology, in selecting the overshoot level C, the overshoot level C is selected based on the previously set parameter table P. Therefore, calculation is not necessary for selecting the overshoot level C and the overshoot level C is selected promptly. In the present technology, the parameter table P is set based on the gradation level X and the gradation level X is determined with using the first function Gn in which the values of the response waveform gn are added for a predetermined time period. The first function Gn includes an average value obtained from the values of the response waveform gn. Accordingly, the overshoot level C is selected by using an average value that is calculated from the values obtained for a predetermined period similarly to the recognition of the liquid crystal display element by humans' eyes. Therefore, tailing or an image failure is less likely to occur.

In the present technology, the parameter table P is set based on gradation difference S between the gradation level X and the gradation level Y. The gradation level X is set based on the first function Gn in which an average value of the response waveform gn is calculated and the gradation level X typically represents a gradation level that is recognized by humans' eyes. The gradation level Y is a gradation level at a moment of the response waveform gn and that is measured by a measurement instrument. The parameter table P is set based on the gradation difference S, and therefore, tailing or an image failure is less likely to occur due to difference between the gradation level recognized by humans' eyes and the gradation level measured by the measurement instrument.

The method may further includes applying the overshoot signal to the liquid crystal display element every frame period, and storing the overshoot signal applied to the liquid crystal display element in a previous frame period. The conversion table K is preferably set based on the response waveform gn that is obtained when the overshoot signal is applied. Accordingly, a display result of the liquid crystal display element in the previous frame period is feedback used via the parameter table and the parameter table is set with considering the current environmental influence such as a temperature.

The present technology can be applied to a drive circuit that carries out the above methods of driving a display panel. A liquid crystal display element driving device of the present technology is a liquid crystal display element driving device that applies an overshoot signal to the liquid crystal display element to display an image on the liquid crystal display element. The liquid crystal display element driving device includes a selecting part configured to select an overshoot level C from a plurality of shoot levels Dn in a case that a gradation level changes from a gradation level A before changing a gradation level, a gradation level C corresponding to an overshoot signal, and a gradation level B that is a target gradation, in this order, and a storing part storing response waveforms gn each corresponding to each of the overshoot levels Dn and an ideal waveform f that is an ideal waveform with which the gradation level is shifted from the gradation level A to the gradation level B in an ideal manner. The selecting part obtains difference values between corresponding momentary values of one of the response waveforms gn and momentary values of the ideal response waveform f for a plurality of times for a predetermined time period. The selecting part adds the difference values obtained for the predetermined time period and obtains a minimum first error value E1. The selecting part selects one of the overshoot levels Dn that corresponds to the response waveform gn having the minimum first error value E1 as the overshoot level C.

With using such a driving device, the driving method based on the first error value E1 is achieved. Therefore, tailing or an image failure is less likely to occur.

Another aspect of the present technology includes a liquid crystal display element driving device that includes a selecting part configured to select an overshoot level C from a plurality of shoot levels Dn in a case that a gradation level changes from a gradation level A before changing a gradation level, a gradation level C corresponding to an overshoot signal, and a gradation level B that is a target gradation, in this order, and a storing part storing response waveforms gn each corresponding to each of the overshoot levels Dn and an ideal waveform f that is an ideal waveform with which the gradation level is shifted from the gradation level A to the gradation level B in an ideal manner. The selecting part obtains a function value with a first function Gn in which momentary values of one of the response values gn are obtained and added for a predetermined time period and by changing addition start time at which the adding of the momentary values of the response value is started, the function value changes as time passes. The selecting part obtains a function value with a second function F in which momentary values of the ideal waveform f are obtained and added for the predetermined time period and by changing addition start time at which the adding of the momentary values of the ideal waveform f is started, the function value changes as time passes. The selecting part obtains function values of the first function Gn and function values of the second function F and obtains difference values between the corresponding function values of the first function Gn and the second function F for the predetermined time period, and adds the difference values obtained for the predetermined time period and obtains a second minimum error value E2, and the selecting part selects one of the overshoot levels Dn that corresponds to the response waveform gn having the minimum second error value E2 as the overshoot level C.

With using such a driving device, the driving method based on the second error value E2 is achieved. Therefore, tailing or an image failure is less likely to occur.

Another aspect of the present technology includes a liquid crystal display element driving device that includes a selecting part configured to select an overshoot level C from a plurality of shoot levels Dn in a case that a gradation level changes from a gradation level A before changing a gradation level, a gradation level C corresponding to an overshoot signal, and a gradation level B that is a target gradation, in this order, a storing part storing response waveforms gn each corresponding to each of the overshoot levels Dn and an ideal waveform f that is an ideal waveform with which the gradation level is shifted from the gradation level A to the gradation level B in an ideal manner, the storing part further storing a conversion table K based on which a function value obtained by a first function Gn is converted to a gradation level X, the function value obtained by the first function Gn in which momentary values of one of the response values gn are obtained and added for a predetermined time period and by changing addition start time at which the adding of the momentary values of the response value is started, the function value changes as time passes, and a setting part configured to set a parameter table P corresponding to one of the overshoot levels Dn for each of the gradation level A and the gradation level B, the setting part configured to set one of the overshoot levels Dn based on a difference value S between the gradation level X after elapse of a predetermined time period and a gradation level Y of the response waveform gn. The selecting part selects the overshoot level C based on the parameter table P.

With using such a driving device, the driving method based on the parameter table P is achieved. Therefore, tailing or an image failure is less likely to occur.

### ADVANTAGEOUS EFFECT OF THE INVENTION

According to the present invention, in an overdrive method, tailing or an image failure is less likely to be caused in moving images.

### BRIEF DESCRIPTION OF THE DRAWINGS

FIG. 1 is a block diagram illustrating a configuration of a liquid crystal display device 10;

FIG. 2 is a graph illustrating response waveforms gn and an ideal waveform f;

FIG. 3 is a flowchart illustrating a method of selecting an overshoot level C;

FIG. 4 is a graph illustrating a relationship between a response waveform g1 and the ideal waveform f1;

FIG. 5 is a flowchart illustrating a method of selecting an overshoot level C;

FIG. 6 is a graph illustrating a relationship between a response waveform g11 and the ideal waveform f;

FIG. 7 is a block diagram illustrating a configuration of a liquid crystal display device 210;

FIG. 8 is a flowchart illustrating a method of setting LUT; and

FIG. 9 is a graph illustrating a process of converting a function value of third function H into gradation X using a gamma property K.

### BEST MODE FOR CARRYING OUT THE INVENTION

### First Embodiment

A first embodiment of the present invention will be described with reference to the drawings.

### 1. Configuration of Liquid Crystal Display Device

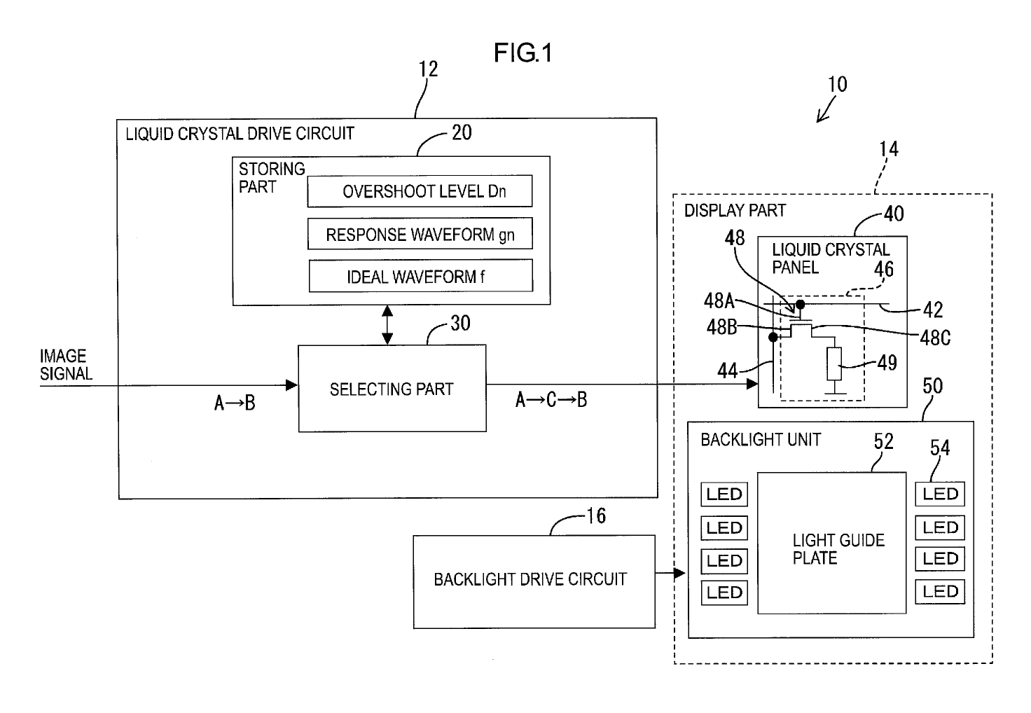

As illustrated in FIG. 1, a liquid crystal display device 10 includes a liquid crystal drive circuit 12 (an example of a drive circuit), a display part 14, and a backlight drive circuit 16. The display part 14 includes a liquid crystal panel 40 (an example of a liquid crystal display element) and a backlight unit 50.

The liquid crystal panel 40 includes scan lines 42, data lines and pixels 46. Each of the pixels 46 is a unit display element for driving the liquid crystal panel 40 and includes a switch device 48 and a pixel electrode 49. The switch device 48 includes a switching electrode 48A and data electrodes 48B, 48C. The switching electrode 48A is connected to the corresponding scan line 42. The data electrode 48B is connected to the corresponding data line 44 and the data electrode 48C is connected to the pixel electrode 49. The pixel electrode 49 is arranged to face liquid crystal molecules enclosed in the liquid crystal panel 40.

In a driving operation, a scan signal is applied to the switching electrode 48A via the scan line 42 in the liquid crystal panel 40. The scan signal has voltage higher than a threshold voltage of the switch device 48 and accordingly, the switch device 48 is turned on. Next, an overshoot signal is applied to the pixel electrode 49 via the data line 44 and the data electrodes 48B, 48C. Accordingly, voltage increase of the pixel electrode 49 changes and according to the change of the voltage increase, the liquid crystal molecules arranged corresponding to the pixel electrode 49 are polarized. This changes brightness of the pixel 46. A polarizing angle of the liquid crystal molecules of the pixel 46 changes by the overshoot signal applied to the scan line 42 and therefore, various brightness values are provided. Thus, various gradation levels can be achieved in the pixel 46.

The backlight unit 50 is arranged on a rear-surface side of the liquid crystal panel 40. The backlight unit 50 includes LEDs (light emitting diodes) 54 that are light sources and a light guide plate 52. The LEDs 54 are arranged to face each side surface of the light guide plate 52. The light guide plate 52 is arranged such that a main surface thereof faces the liquid crystal panel 40. Light from the LEDs 54 enters the side surface of the light guide plate 52 and is guided through the light guide plate 52 to the main surface thereof facing the liquid crystal panel 40. Therefore, the side surface of the light guide plate 52 is a light entrance surface 52A through which the light from the LEDs 54 enters the light guide plate 52. The main surface of the light guide plate 52 is a light exit surface 52B from which the light traveling through the light guide plate 52 exits to the liquid crystal panel 40. Thus, the backlight unit 50 is a backlight unit of an edge-light type (a side-light type) that includes the LEDs 54 on each long-side edge and the light guide plate 52 in its middle portion.

The backlight drive circuit 16 is connected to the LEDs 54 that configure the backlight unit 50. The backlight drive circuit 16 supplies current to each of the LEDs 54 and controls a current amount supplied to each LED 54 to control an amount of light that enters the light guide plate 52 from each LED 54.

The liquid crystal drive circuit 12 transmits to the liquid crystal panel 40 image signals transmitted from an external device (not illustrated). An image signal includes a scan signal and a data signal. The liquid crystal drive circuit 12 applies a scan signal to the scan line 42 of the liquid crystal panel 40. The scan signal is transmitted from the external device. The liquid crystal drive circuit 12 converts a data signal into an overshoot signal and transmits the overshoot signal to the liquid crystal panel 40. The data signal is transmitted from the external device. An image signal is transmitted to the liquid crystal drive circuit 12 at every frame interval T that is determined according to a usage object of the liquid crystal panel 40. The liquid crystal drive circuit 12 executes a process of converting a data signal into an overshoot signal at every frame period T.

The liquid crystal drive circuit 12 includes a storing part 20 and a selecting part 30.

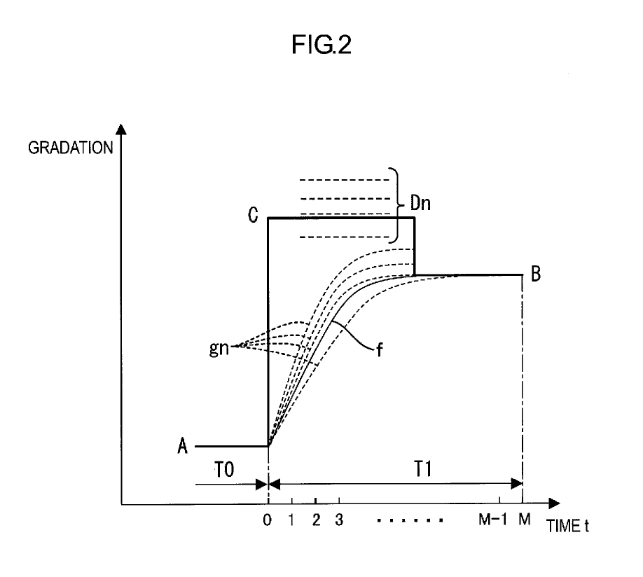

As illustrated in FIG. 2, the storing part 20 stores a plurality of overshoot levels Dn and a plurality of response waveforms gn are obtained corresponding to each of the overshoot levels Dn. Each of the response waveforms gn may be previously measured and obtained or may be previously calculated with a simulation. The storing part 20 stores an ideal waveform f that is previously set. The ideal waveform f has a function in which the reached gradation level that is obtained after elapse of a predetermined time period reaches a target gradation level and also has a function in which tailing or an image failure that is recognized by humans' eyes does not occur. The storing part 20 stores momentary values of the response waveform gn at every unit time period (gn(1), gn(2), gn(3), . . . ) and momentary values of the ideal waveform f at every unit time period (f(1), f(2), f(3), . . . ).

The selecting part 30 selects an overshoot level of an overshoot signal if receiving a data signal from the external device. As illustrated in FIG. 2, a gradation level of the liquid crystal panel 40 that reaches at a previous frame period T0 is a gradation level A and a target gradation level at a current frame period T1 is set to be a gradation level B. In such a case, if receiving an image signal that requires a gradation level of the liquid crystal panel 40 to rise from the gradation level A to the gradation level B, the selecting part 30 selects a gradation level C (an overshoot level C) that is higher than the gradation level B among the overshoot levels Dn stored in the storing part 20. Then, the selecting part 30 inputs to the liquid crystal panel 40 the overshoot signal in which the gradation level changes from A, C to B in this order.

### 2. Selecting Process of Selecting Overshoot Level C

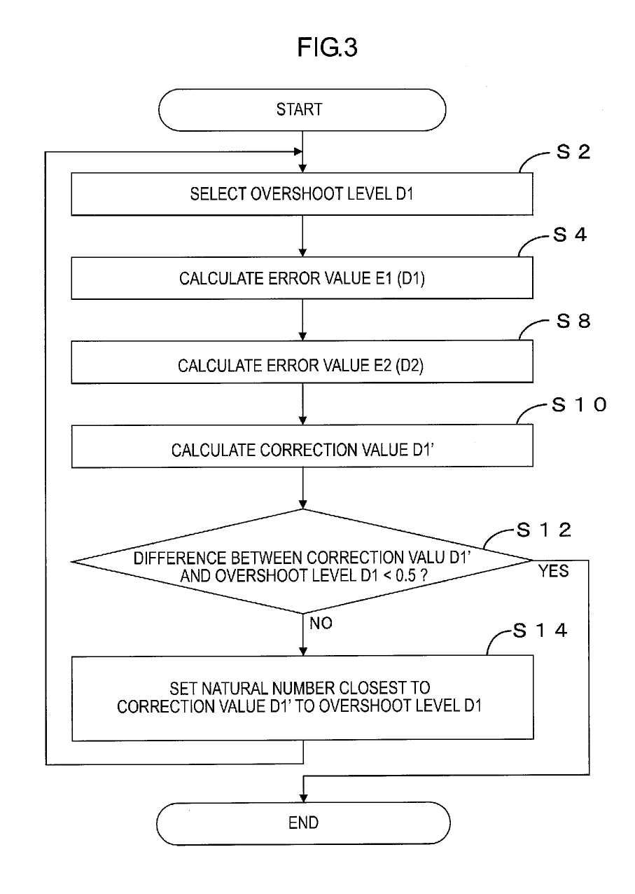

A selecting process in which the selecting part 30 selects an overshoot level C will be explained with reference to FIG. 3.

The selecting part 30 selects an overshoot level D1 from a plurality of overshoot levels Dn (step S2). A selecting method of selecting the overshoot level D1 is not specified. One of the overshoot levels Dn that is closest to the target gradation level B may be selected as the overshoot level D1 or the overshoot level D1 may be previously determined based on the gradation level A before changing and the target gradation level B.

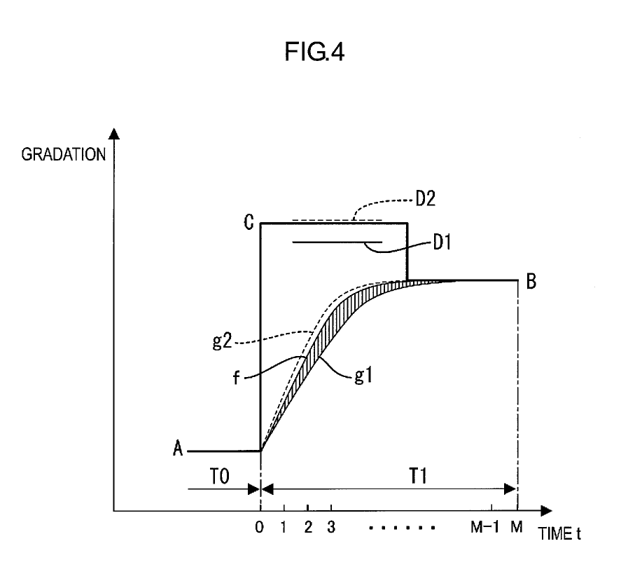

Next, the selecting part 30 determines whether the overshoot level D1 is most appropriate and effective for the overshoot level C. In evaluating the overshoot level D1, the selecting part 30 obtains a difference value between the momentary values of the response waveform g1 and the ideal waveform f corresponding to the overshoot level D1. The selecting part 30 calculates an error value E1 (D1) by adding the difference values obtained for the frame period T1 after the overshoot signal corresponding to the overshoot level D1 is applied (step S4). The error value E1(D1) is obtained by a following formula 1. In the formula 1, M is referred to as a number of divisions that are obtained if the frame period T is divided by a unit time interval. In FIG. 4, the error value E1(D1) represents an area of a portion illustrated by diagonal lines. As the area is smaller, the error value E1(D1) is smaller and the response waveform g1 and the ideal waveform f preferably matches each other. An average value is obtained from the difference values between the momentary values of the response waveform g1 and the ideal waveform f and the obtained average value is included in the error value E1(D1).

$$E 1 ( D 1 ) = {E}_{t = 1} ( ( t ) - g 1 ( t ) ) \qquad Formula 1$$

Next, the selecting part 30 determines if the error value E1 (D1) calculated based on the overshoot level D1 is a minimum value among the error values E1(D1) that are calculated based on each of the overshoot levels Dn. The selecting part 30 makes this determination using Newton method.

In Newton method, the selecting part 30 selects an overshoot level D2 that is adjacent to the overshoot level D1 and calculates an error value E1(D2) according to the similar steps as in the case of the error value E1(D1) (step S8). The error value E1(D2) is calculated by a following formula 2.

$$E 1 ( D 2 ) {=}_{t = 1} ( t ) - g 2 ( t ) ) \qquad Formula 2$$

Next, the selecting part 30 calculates a correction value D1′ of the overshoot level D1 (step S10). The correction value D1′ is calculated by a following formula 3.

$$D {1}^{′} = D 1 + E 1 ( D {1}^{′} ) - E 1 ( D 1 ) = D 1 + \frac{E 1 ( D 1 )}{EV ( Di ) El ( D 1 ) - E 1 ( D 2 )} \qquad Formula 3$$

In the formula 3, approximate calculation is made using one of following formulae 4 to 6.

$$\begin{matrix}E 1 ( D {1}^{′} ) = 0 & Formula 4 \\ D 2 - D 1 = 1 & Formula 5 \\ Er ( D 1 ) = \frac{E 1 ( D 2 ) - E 1 ( D 1 )}{D 2 - D 1} & Formula 6\end{matrix}$$

The selecting part 30 compares the overshoot level D1 and the correction value D1′ (step S12) and if determining that difference between the overshoot level D1 and the correction value D1′ is 0.5 or more (step S12: NO), the selecting part 30 sets a natural number that is closest to the correction value D1′ to the overshoot level D1 (step S14). Thereafter, the processes from step S2 to S10 will be carried out again. If determining that difference between the overshoot level D1 and the correction value D1′ is smaller than 0.5, the selecting part 30 selects the overshoot level D1 as the overshoot level C.

### 3. Effects of the First Embodiment

(1) In the present embodiment, the liquid crystal panel 40 is driven by using an overshoot signal. This increases polarizing speed of liquid crystal molecules contained in the liquid crystal panel 40. Therefore, response speed is increased in the liquid crystal panel 40 using polymer liquid crystal.

(2) In the present embodiment, an average value is obtained from difference values between the momentary values of the response waveform g1 and the ideal waveform f that are obtained for a frame period T and the obtained average value is the error value E1(D1). The overshoot level C is selected with using the error value E1(D1). Therefore, similarly to the recognition by humans' eyes, the overshoot level C is selected by using the average value calculated from the difference values obtained for a predetermined period. Tailing or an image failure in moving images is less likely to occur.

(3) In the present embodiment, the selecting part 30 determines if the overshoot level D1 is most appropriate by using Newton method. By using Newton method, the selecting part 30 promptly selects an overshoot level at which the error value E1 is minimum without using a complicated formula.

### Second Embodiment

A second embodiment of the present invention will be explained with reference to the drawings. A liquid crystal display device 110 includes a liquid crystal drive circuit 112 and a selecting part 130. In the second embodiment, the selecting part 130 selects an overshoot level C in a selecting method different from the first embodiment. In the following explanation, redundant explanation will be omitted.

### 1. Selecting Process of Selecting Overshoot Level C

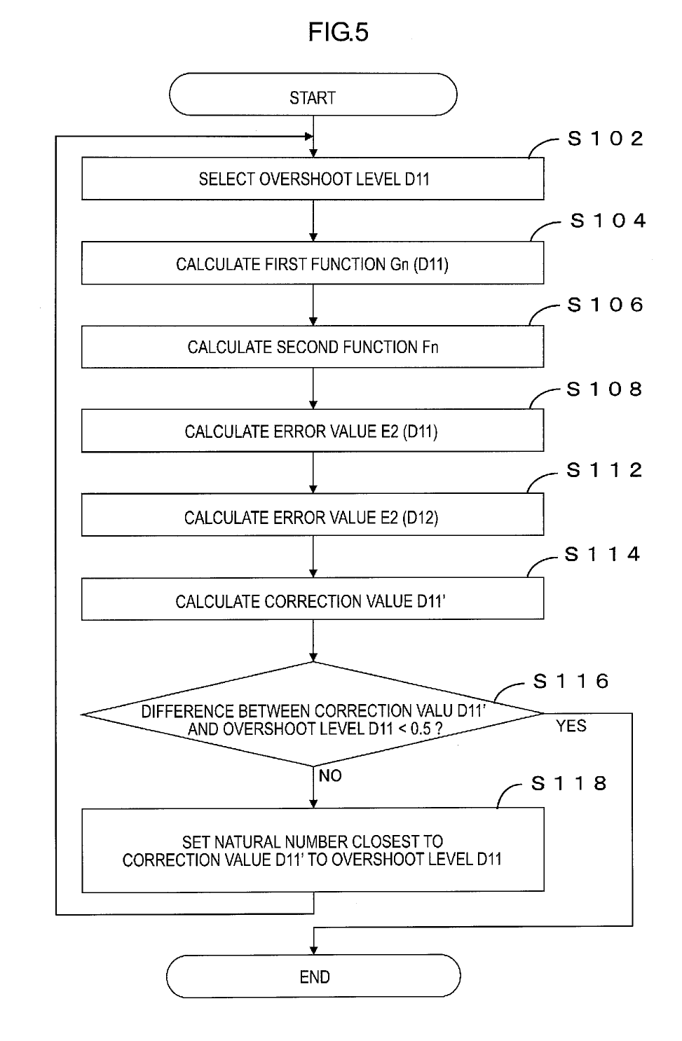

A selecting process in which the selecting part 130 selects an overshoot level C will be explained with reference to FIG. 5.

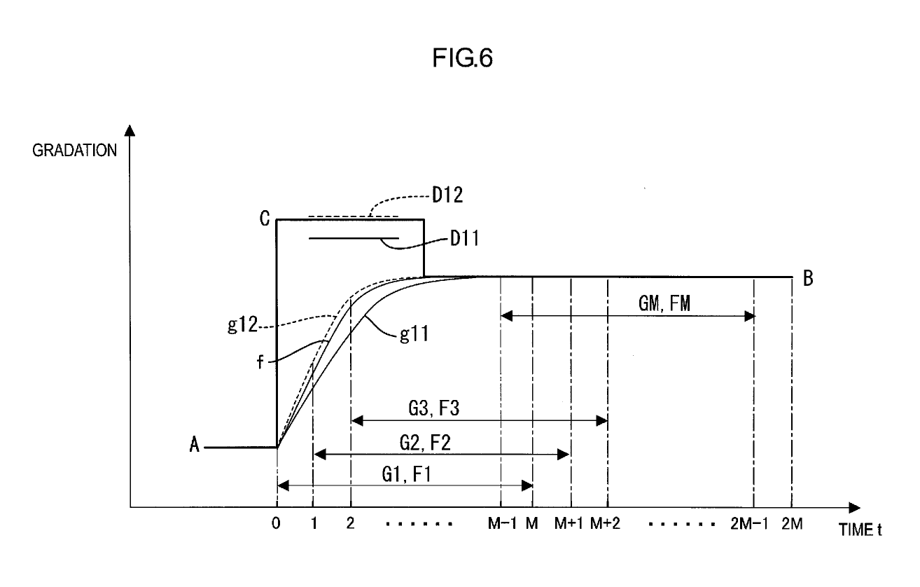

The selecting part 130 selects an overshoot level D11 from a plurality of overshoot levels Dn (step S102). The selecting part 130 determines whether the overshoot level D11 is most appropriate for the overshoot level C. The selecting part 130 first calculates a first function G(D11) and a second function F (step s104 and step S106). In the first function G(D11), momentary values of a response waveform g11 corresponding to the overshoot level D11 are obtained and added for a frame period T. As illustrated in FIG. 6, the selecting part 130 shifts addition start time by a unit time period and calculates the first functions G(D11) in a number of M (obtained in one frame period). The first function G(D11) is calculated by a following formula 7. In the first function G(D11), an average value is obtained from the momentary values of the response waveform g11 that are obtained for the one frame period T.

$$G 1 ( D 11 ) = {E}_{t = 1} g 11 ( t ) , G 2 ( D 11 ) = {E}^{M + 1} gl {1}^{0} ( , … , GM ( D 11 ) = {E}^{2 Aff - 1} g 11 ( t ) \qquad Formula 7$$

In the second function, the momentary values of the ideal waveform f are obtained and added for a frame period T. As illustrated in FIG. 6, in calculating the second function F, the selecting part 130 shifts the addition start time by a unit time period and calculates the second function F in a number of M. The second function F is calculated by a following formula 8. Similarly to the first function G(D11), in the second function F, an average value is obtained from the momentary values of the ideal waveform f that are obtained for the frame period T.

$$Fl = {{E}_{t = 1}}^{Al} f ( t ) , F 2 {{=}_{t = 2}}^{M + 1} At ) , … , F M {{=}_{t = M}}^{2 M = 1} f ( t ) \qquad Formula 8$$

Next, the selecting part 130 obtains a difference value between the function values of the first function G(D11) and the second function F and calculates an error value E2 (D11) (step S108). The error value E2 (D11) is obtained by adding the difference values obtained for the frame period T. The error value E2(D11) is calculated by a following formula 9. In the error value E2(D11), an average value is obtained from the difference values between the function values of the first function G(D11) and the second function F that are obtained for the frame period T.

E2(D11)=E(F(t)−G(t)(D11))t Formula 9

Next, the selecting part 130 determines if the error value E2(D11) calculated by using the overshoot level D11 is minimum among the error values E2(Dn) calculated by using each of the overshoot levels Dn. The selecting part 130 makes the determination by using Newton method.

In Newton method, the selecting part 130 selects an overshoot level D12 that is adjacent to the overshoot level D11 and calculates the error value E2 (D12) according to the steps used in calculating the error value E2(D11) (step S112). The error value E2(D12) is calculated by a following formula 10.

### Formula 10:

$$E 2 ( D 12 ) = {E}_{t = i} ( F ( t ) - G ( t ) ( D 12 ) )$$

Next, the selecting part 130 calculates a correction value D11′ of the overshoot level D11 (step S114). The correction value D11′ is calculated by using a following formula 11.

$$D {11}^{′} = Dll + \frac{E 2 ( D {11}^{′} ) E 2 ( D 11 )}{ET ( D 11 )} = D 1 + \frac{E 2 ( D 11 )}{E 2 ( D 11 ) - E 2 ( D 12 )} \qquad Formula 11$$

In the formula 11, approximate calculation is made using one of following formulae 12 to 14.

$$\begin{matrix}E 2 ( D {11}^{′} ) = 0 & Formula 12 \\ D 12 - D 11 = 1 & Formula 13 \\ E {2}^{′} ( D 11 ) = \frac{E 2 ( D 12 ) - E 2 ( D 11 )}{D 12 - D 11} & Formula 14\end{matrix}$$

The selecting part 130 compares the overshoot level D11 and the correction value D11′ (step S116) and if determining that difference between the overshoot level D11 and the correction value D11′ is 0.5 or more (step S116:NO), the selecting part 130 sets a natural number that is closest to the correction value D11′ to the overshoot level D11 (step S118). Thereafter, the processes from step S102 to S114 will be carried out again. If determining that difference between the overshoot level D11 and the correction value D11′ is smaller than 0.5, the selecting part 130 selects the overshoot level D11 as the overshoot level C.

### 2. Effects of the Second Embodiment

(1) In the second embodiment, an average function value of the first function G(D11) and an average function value of the second function F are calculated from the momentary values of the response waveform g11 and the ideal waveform f that are obtained for the frame period T. An average value is obtained from the difference values between the function values of the first function G(D11) and the second function F that are obtained for the frame period T. The obtained average value is the error value E2(D11) and the overshoot level C is selected by using the error value E2(D11). Therefore, similarly to the recognition by humans' eyes, the overshoot level C is selected by using the average value calculated from the difference values obtained for a predetermined period. Tailing or an image failure in moving images is less likely to occur.

### Third Embodiment

A third embodiment of the present invention will be explained with reference to the drawings. A liquid crystal display device 210 includes a liquid crystal drive circuit 212 that has a configuration different from the liquid crystal display device 10 of the first embodiment. In following explanation, redundant explanation will be omitted.

### 1. Configuration of Liquid Crystal Drive Circuit

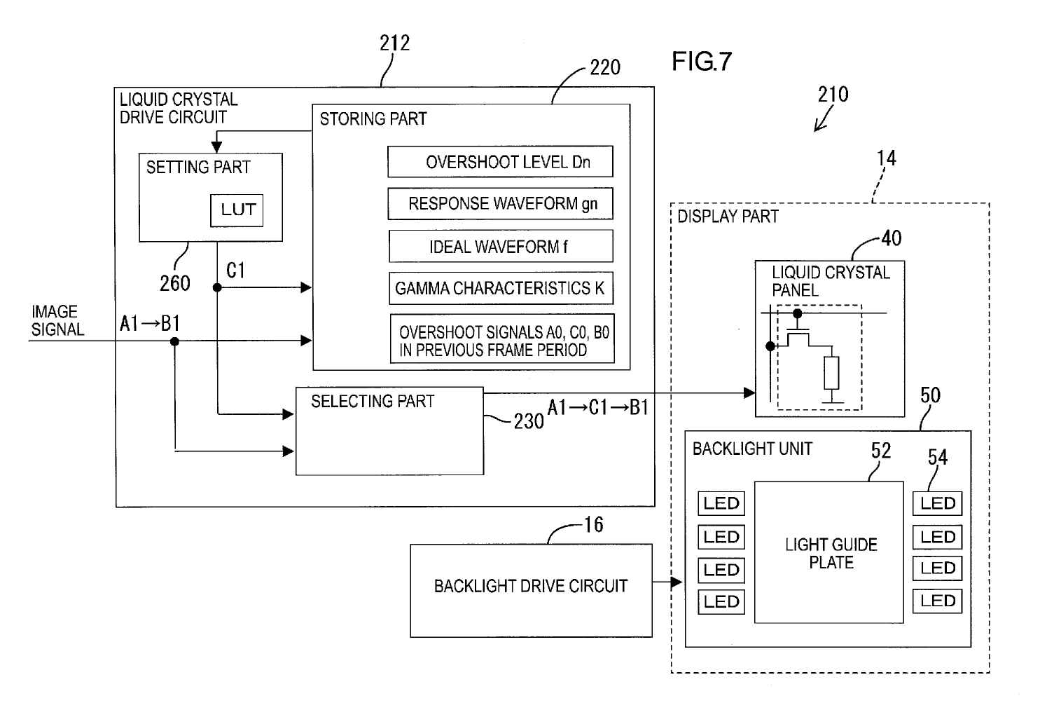

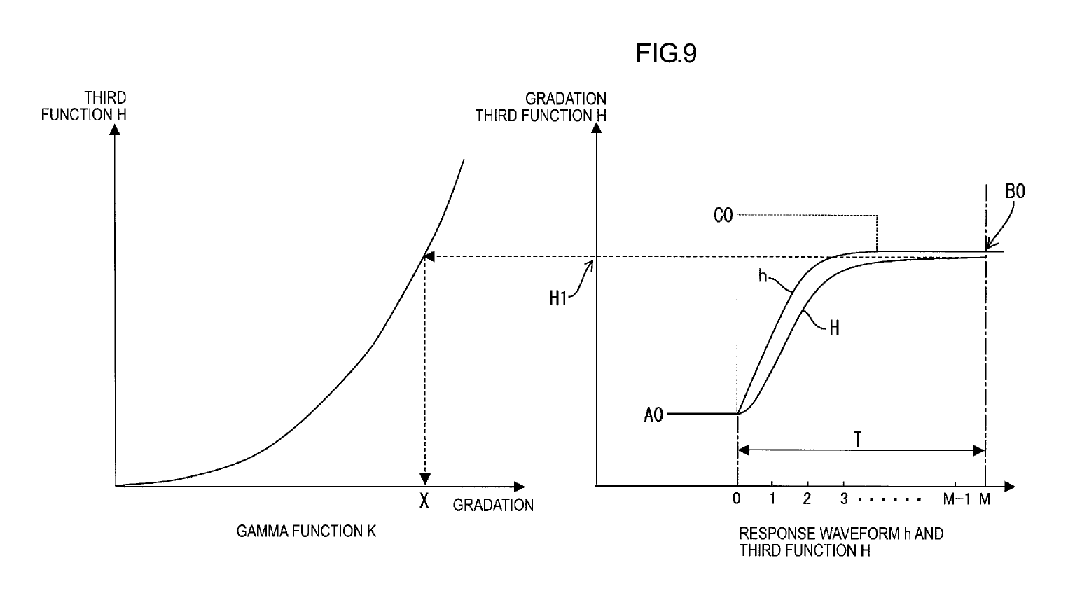

As illustrated in FIG. 7, the liquid crystal drive circuit 212 includes a storing part 220, a selecting part 230 and a setting part 260. The storing part 220 has a function same as the storing part 20 of the first embodiment and also stores gamma characteristics K (an example of a conversion table K: refer to FIG. 9 based on which a function value of a third function H is converted to gradation level X. The storing part 220 stores overshoot signals that are actually applied to the liquid crystal panel 40 during a previous frame period T0. Image signals are transmitted to the storing part 220 from the external device and combination of a gradation level A0 before changing and a gradation level B0 after changing in the previous frame period T0 is input to the storing part 220. The gradation level B0 after changing is substantially same as the gradation level A before changing in the current frame period T1. The storing part 220 is connected to the setting part 260 and an overshoot level C0 in the previous frame period T0 is input to the storing part 220. Accordingly, the storing part 220 stores the overshoot signal that is actually applied to the liquid crystal panel 40 in the previous frame period T0. Namely, the storing part 220 stores the overshoot signal in which the gradation level changes from A0, C0 to B0 in this order.

In receiving a data signal from the external device, the selecting part 230 selects an overshoot level C of the overshoot signal. The selecting part 230 is connected to the setting part 260. A look up table (LUT) (an example of a parameter table P) is set to the setting part 260. The selecting part 230 selects an overshoot level C based on the look up table and inputs to the liquid crystal panel 40 an overshoot signal in which the gradation level changes from A, C to B in this order.

In the LUT set in the setting part 260, change in the gradation level caused by the image signal supplied from the external device is set. Namely, each combination of the gradation level A and the gradation level B corresponds to one of a plurality of overshoot levels Dn in the LUT. The setting part 260 is connected to the selecting part 230 and the selecting part 230 selects an overshoot level C based on the LUT. The setting part 260 is connected to the storing part 220 and the storing part 220 stores the overshoot level C that is selected by the selecting part 230. Accordingly, the storing part 230 stores the overshoot level C0 in the previous frame period T0.

### 1. Setting Process in LUT

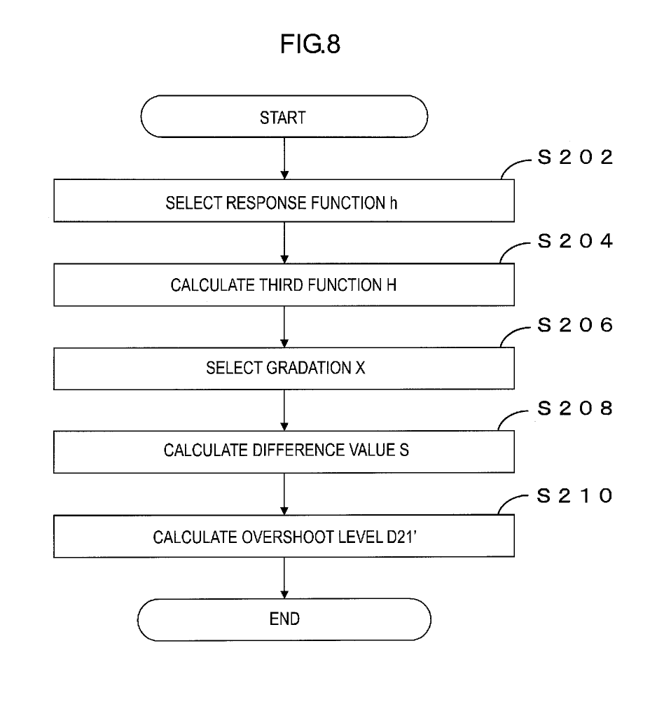

A setting process in the LUT executed by the setting part 260 will be explained with reference to FIGS. 8 and 9. The setting process in the LUT is carried out prior to inputting of image signals from the external device and terminated during the inputting of the image signals. Therefore, the selecting part 230 selects an overshoot level C using the LUT that is newly set by the setting part 260 in receiving image signals.

One overshoot level D21 is selected from a plurality of overshoot levels Dn with using one of the methods in the first embodiment and the second embodiment so as to correspond to the gradation level A before changing and the target gradation level B. The setting part 260 previously has the LUT in which the overshoot level D21 corresponds to combination of the gradation level A and the gradation level B. The setting process includes an adjustment process in which the overshoot level D21 set in the previously set LUT is adjusted appropriately for an environment in which the liquid crystal display device 210 is placed.

The setting part 260 selects a response waveform h of the liquid crystal panel 40 in the previous frame period T0 based on the overshoot signal in the previous frame period T0 that is stored in the storing part 220 (step S202). Namely, the setting part 260 selects one of the response waveforms gn as the response waveform h based on the change of the gradation level during the previous frame period T0 (A0->C0->B0). Next, the setting part 260 calculates a third function H (one of the first function Gn) (step S204). The third function H is calculated by adding momentary values of the response waveform h that are obtained for the frame period T. The third function H is calculated by a following formula 15.

$$H i {h}_{t} ( t ) \qquad Formula 15$$

FIG. 9 illustrates a relationship between the response waveform h and the third function H. If the response waveform h is a rising response in which the gradation of the liquid crystal panel 40 increases from the gradation level A0 to the gradation level B0, the third function H rises after rising of the response waveform h. Therefore, even if the response waveform h after the elapse of the one frame period T reaches the target gradation level B0 (corresponds to the gradation level Y), the response function H does not reach a maximum value corresponding to the target gradation level B0. The setting part 260 calculates a function value H1 of the response function H after the elapse of one frame period T and selects a corresponding gradation level DX (refer to an arrow 74) by using the gamma characteristics K (refer to an arrow 72) illustrated in FIG. 9.

The setting part 260 compares the target gradation level B0 and the selected gradation level X and calculates a difference value S between the target gradation level B0 and the selected gradation level X (step S208). The difference value S is caused by difference between the overshoot level D21 set in the LUT and the most appropriate overshoot level C and this difference is caused by the change in temperature or humidity of an environment in which the liquid crystal display device 210 is arranged. The setting part 260 adjusts the overshoot level D21 based on the difference value S and calculates an overshoot level D21′ (step S210). Then, the setting part 260 changes the overshoot level D21 set in the LUT to the overshoot level D21′. The setting part 260 repeatedly executes the above setting operation for each of the pixels 46 included in the liquid crystal panel 30 and completes setting of the LUT.

### 2. Method of Selecting Overshoot Level C

The selecting part 30 selects the overshoot level C using the LUT that is set by the setting part 260. The selecting part 30 is connected to the setting part 260 and selects the overshoot level D21′ corresponding to the combination of the gradation level A before changing and the target gradation level B as the overshoot level C. Namely, the selecting part 30 selects the overshoot level corresponding to the image signal from the external device.

### 3. Effects of the Third Embodiment

(1) In the third embodiment, in selecting the overshoot level C, the overshoot level C is selected based on the previously set LUT. Therefore, the overshoot level C is selected promptly.

(2) In the third embodiment, the LUT is set by using the third function H (one of the first function Gn) in which an average value is calculated from the momentary values of the response waveform h that are obtained for the frame period T. The overshoot level D21 is adjusted based on the LUT. The overshoot level D21 is adjusted by using an average value that is calculated from the values obtained for a predetermined period as is adjusted by recognition by humans' eyes. Therefore, tailing or an image failure in the moving image is less likely to occur.

(3) In the third embodiment, the LUT is adjusted based on the difference value S between the gradation level B0 and the gradation level X. The gradation level X is set based on the third function H in which an average value of the response waveform gn is calculated and the gradation level X typically represents a gradation level that is recognized by humans' eyes. The gradation level B0 is a reached gradation level of the response waveform h and represents a gradation level that is measured by a measurement instrument. The LUT is set based on the difference value S, and therefore, tailing or an image failure is less likely to occur due to difference between the gradation level recognized by humans' eyes and the gradation level measured by the measurement instrument.

(4) In the third embodiment, the overshoot signal in the current frame period T1 is selected with feedback using the overshoot signal that is actually applied to the liquid crystal panel 40 in the previous period T. The LUT is set with feedback using the response waveform in the previous frame period T0. Therefore, the LUT is set with considering the current environmental influence such as a temperature, and tailing or an image failure is less likely to occur.

### Other Embodiments

As describe above, the embodiments of the present invention have been described. However, the present invention is not limited to the above embodiments described in the above description and the drawings. The following embodiments are also included in the technical scope of the present invention, for example.

(1) In the above embodiments, in calculating the error value E1, the difference values between the response waveform g1 and the ideal waveform f are added for a predetermined period. However, the error value E1 is not necessarily calculated in this method. Exponentiation may be carried out with the difference value between the response waveform g1 and the ideal waveform f as the base and the exponent of 1 or more and the values obtained by the exponentiation for a predetermined period may bee added to calculate the error value E1. In exponentiating the difference value between the response waveform g1 and the ideal waveform f with the exponent of 1 or more, as the difference value is greater, the error value E1 increases, and as the difference value is smaller, the error value E1 decreases. Accordingly, one of the overshoot levels Dn that has minimum error value E1 is precisely selected. Same effects are obtained for the error value E2 that is calculated based on the first function Gn and the second function F.

(2) Because the exponent is set to 1, one of the overshoot levels Dn that has a minimum error value E1 (a minimum error value E2) is selected promptly by using Newton method compared to a case in which other exponent is used.

(3) In the above embodiments, the overshoot levels Dn having a minimum error value E1 are calculated by using Newton method. However, it is not limited thereto and various algorisms for calculating a convergence value may be used.

(4) In the above embodiments, the LEDs are used as the light sources. However, light sources other than the LEDs may be used. The light sources are arranged to be the edge-light type. However, the light sources may be arranged on a rear-surface side of the light guide plate 52 and to be a direct type.

### EXPLANATION OF SYMBOLS

10: Liquid crystal display device, 12: Liquid crystal drive circuit, 14: Display part, 16: Backlight drive circuit, 20: Storing part, 30: Selecting part, 40: Liquid crystal panel, 42: Scan line, 44: Data line, 46: Pixel, 48: Switch device, 49: Pixel electrode, 50: Backlight unit, 260: Setting part

1. A method of driving a liquid crystal display element comprising:
selecting an overshoot level C from a plurality of shoot levels Dn in a case that a gradation level changes from a gradation level A before changing a gradation level, a gradation level C corresponding to an overshoot signal, and a gradation level B that is a target gradation, in this order; and
applying the overshoot level C selected by the selecting step to the liquid crystal display element, wherein the selecting step includes:
obtaining a plurality of response waveforms gn each corresponding to each of the plurality of overshoot levels Dn,
setting an ideal waveform f that is an ideal response waveform with which the gradation level is shifted from the gradation level A to the gradation level B in an ideal manner,
obtaining difference values between corresponding momentary values of one of the response waveforms gn and momentary values of the ideal response waveform f for a plurality of times for a predetermined time period,
adding the difference values obtained for the predetermined time period and obtaining a minimum first error value E1, and
selecting one of the overshoot levels Dn that corresponds to the response waveform gn having the minimum first error value E1 as the overshoot level C.

2. The method according to claim 1, wherein in the adding step, exponentiating the difference value between the response waveform gn and the ideal waveform f is exponentiated with an exponent of 1 or more, and carrying out the exponentiation a plurality of times for the predetermined time period and adding values obtained by the exponentiation for the predetermined time period and obtaining the minimum first error value E1.

3. The method according to claim 1, wherein selecting the one of the overshoot levels Dn as the overshoot level C with using Newton method.

4. The method according to claim 3, wherein the exponent is 1.

5. A method of driving a liquid crystal display element comprising:
selecting an overshoot level C from a plurality of shoot levels Dn in a case that a gradation level changes from a gradation level A before changing a gradation level, a gradation level C corresponding to an overshoot signal, and a gradation level B that is a target gradation, in this order; and
applying the overshoot level C selected by the selecting step to the liquid crystal display element, wherein the selecting step includes:
obtaining a plurality of response waveforms gn each corresponding to each of the plurality of overshoot levels Dn,
setting an ideal waveform f that is an ideal response waveform with which the gradation level is shifted from the gradation level A to the gradation level B in an ideal manner,
obtaining a function value with a first function Gn in which momentary values of one of the response values gn are obtained and added for a predetermined time period and by changing addition start time at which the adding of the momentary values of the response value is started, the function value changes as time passes,
obtaining a function value with a second function F in which momentary values of the ideal waveform f are obtained and added for the predetermined time period and by changing addition start time at which the adding of the momentary values of the ideal waveform f is started, the function value changes as time passes,
obtaining difference values between the corresponding function values of the first function Gn and the second function F for the predetermined time period, and adding the difference values obtained for the predetermined time period and obtaining a second minimum error value E2, and
selecting one of the overshoot levels Dn that corresponds to the response waveform gn having the minimum second error value E2 as the overshoot level C.

6. The method according to claim 5, wherein in adding the difference values, exponentiating the difference value between the function values of the first function Gn and the second function F with an exponent of 1 or more, and carrying out the exponentiation a plurality of times for the predetermined time period and adding values obtained by the exponentiation for the predetermined time period and obtaining the minimum second error value E2.

7. The method according to claim 4, wherein selecting the one of the overshoot levels Dn as the overshoot level C with using Newton method.

8. The method according to claim 7, wherein the exponent is 1.

9. A method of driving a liquid crystal display element comprising:
selecting an overshoot level C from a plurality of shoot levels Dn in a case that a gradation level changes from a gradation level A before changing a gradation level, a gradation level C corresponding to an overshoot signal, and a gradation level B that is a target gradation, in this order; and
applying the overshoot level C selected by the selecting step to the liquid crystal display element, wherein the selecting step includes:
obtaining a plurality of response waveforms gn each corresponding to each of the plurality of overshoot levels Dn,
setting an ideal waveform f that is an ideal response waveform with which the gradation level is shifted from the gradation level A to the gradation level B in an ideal manner,
obtaining a function value with a first function Gn in which momentary values of one of the response values gn are obtained and added for a predetermined time period and by changing addition start time at which the adding of the momentary values of the response value is started, the function value changes as time passes, and
setting a conversion table K based on which a function value obtained by the first function Gn is converted to a gradation level X, the method further comprising:
setting a parameter table P corresponding to one of the overshoot levels Dn for each of the gradation level A and the gradation level B, wherein
in the setting step, setting one of the overshoot levels Dn based on a difference value S between the gradation level X after elapse of a predetermined time period and a gradation level Y of the response waveform gn, and
in the selecting step, selecting the overshoot level C based on the parameter table P.

10. The method of claim 9, further comprising:
applying the overshoot signal to the liquid crystal display element every frame period; and
storing the overshoot signal applied to the liquid crystal display element in a previous frame period, wherein
the conversion table K is set based on the response waveform gn that is obtained when the overshoot signal is applied.

11. (canceled)

12. (canceled)

13. (canceled)
